(19) United States
(12) Patent Application Publication
(10) Pub. No.: US 2023/0367971 A1
(43) Pub. Date: Nov. 16, 2023

(54) DATA STRUCTURE OF LANGUAGE RESOURCE AND DEVICE, METHOD AND PROGRAM FOR SUPPORTING SPEECH UNDERSTANDING USING THE SAME

(71) Applicant: NIPPON TELEGRAPH AND TELEPHONE CORPORATION, Tokyo (JP)

(72) Inventor: Tsuyoshi OGURA, Musashino-shi, Tokyo (JP)

(73) Assignee: NIPPON TELEGRAPH AND TELEPHONE CORPORATION, Tokyo (JP)

(21) Appl. No.: 18/026,087

(22) PCT Filed: Sep. 14, 2020
(86) PCT No.: PCT/JP2020/034745

§ 371 Date: Mar. 13, 2023

(51) Int. Cl. G06F 40/40

(52) U.S. Cl. CPC G06F 40/40

(57) ABSTRACT

An object of the present disclosure is to provide a method of configuring a language resource related to a noun, which is considered to be necessary for implementing a system that executes a task of specifying content or an entity of a noun in an utterance or text in natural language processing by a computer in consideration of how much it is required to specify the entity or content referred to by the noun or how to present a specification result. The present disclosure is a data structure of a language resource used for natural language processing by a computer, the data structure of the language resource including, in a data element, at least one of: information regarding a possible “type of identification operation” for each of nouns of a target language; or information regarding a “type of presentation method” of an applicable identification result for each of the nouns of the target language.

### TECHNICAL FIELD

The present disclosure relates to a configuration method of a language resource used for natural language processing by a computer.

### BACKGROUND ART

In natural language processing by a computer, various data related to a target language prepared in advance are often used. Those data are generally referred to as language resources. There are language resources related to various types of data. Among them, in particular, in language resources related to nouns, the following information is stored.
(1) Attributes based on grammatical point of view
(2) Type/conceptual classification for fixed form extraction and question answering tasks
(3) Upper-lower relationship between concepts or things

(1) is attribute data based on a grammatical point of view, such as common nouns, proper nouns, material nouns, and abstract nouns. (2) is data related to classification of the type or concept of the noun, such as a person's name, an organization name, a place name, a date and time, an amount of money, a height, and a distance. (3) is data of knowledge related to relationships present between concepts.

As a representative language resource related to Japanese, there is Japanese meaning outline (see, for example, Non Patent Literature 1). In “GoiTaikei—A Japanese Lexicon”, 300,000 recorded words and 3000 kinds of semantic classifications thereof are defined, and data corresponding to (1) to (3) described above are also recorded for nouns.

In communication, a task of specifying or clarifying content represented by a noun may be required. For example, when content or an entity referred to by a noun appearing in an utterance or text is ambiguous, work of confirming the content or entity is an example of the task.

This task is considered to be composed of two sub-tasks of specifying an entity (specific object or abstract concept) referred to by the noun, and presenting the specified entity. Then, specific processing details required in these sub-tasks varies depending on a type of a target noun or a communication situation or context even for the same noun. Hereinafter, this point will be described in detail.

In the former sub-task, that is, the sub-task of specifying the entity referred to by the noun, what or how much content should be indicated to specify differs depending on the type of the noun, the situation, or the context. For example, in a case where it is necessary to specify a “vehicle of Mr. A”, an issue may be a vehicle type, or an issue may be which vehicle body of a plurality of vehicles parked in front in a parking lot or the like the vehicle is. That is, a noun “vehicle” is a noun in which a vehicle type name may be required to be specified or an individual vehicle body may be required to be specified depending on the situation or the context.

On the other hand, in specifying a noun “vehicle type”, literally the vehicle type name is merely asked, and the individual vehicle body is not required to be specified. In addition, for a noun whose entity is specified as one from the beginning, for example, “Tokyo Tower” or the like, it is not even necessary to perform specification processing in the first place.

In addition, in the latter sub-task described above, that is, the sub-task of presenting the specified entity, what should be or can be indicated and how indication should be or can be performed differ depending on nouns and contexts. For example, in the example of the “vehicle of Mr. A”, in a case where the vehicle type is an issue, the vehicle type name that has been specified may be presented as a voice or a character, that is, a language. However, in a case where specifying the vehicle body is an issue, it is necessary to take a presentation method such as pointing to the vehicle body in front that has been specified, presenting a photograph showing the vehicle body, or presenting a number of a license plate. That is, the noun “vehicle” is a noun for which a method of presenting a specification result differs depending on the situation or the context.

In addition, particularly in natural language processing on a computer, there is a case where a noun specification result is to be presented as a file on the computer in addition to presenting a name and a photograph thereof. For example, if meeting minutes referred to by an utterance “minutes at that time” is edited as a file on the computer, there is also a method of presenting the file itself (with a hyperlink or the like) other than presenting a name of the file also for display of the specification result. That is, the noun “minutes” is also a noun for which the method of presenting the specification result may differ depending on the situation or the context.

As described above, how much it is required to specify the entity or content referred to by the noun or how to present a specification result varies depending on the noun, the situation of communication, or the context.

In a case where a task of specifying content referred to by a noun in communication between humans is performed, humans can appropriately make a detailed determination on the point like the above and select necessary processing.

On the other hand, in natural language processing by a computer, there is no system specialized for a task of specifying the content or entity of a noun in an utterance or text yet. In this regard, not only noun specification processing and presentation processing of a result thereof are not implemented, but also there is no language resource prepared from the viewpoint of execution of such processing. Since the current language resources related to nouns described in the background art do not perform noun classification from the viewpoint as described above and do not assist execution of such a task, under such a current situation, it is not possible to implement a task of specifying the content or entity of a noun in an utterance or text by a computer.

### CITATION LIST

### Non Patent Literature

Non Patent Literature 1: GoiTaikei—A Japanese Lexicon, FIGS. 1 and 2
http://www.kecl.ntt.co.jp/icl/lirg/resources/GoiTaikei/index.html

### SUMMARY OF INVENTION

### Technical Problem

An object of the present disclosure is to provide a method of configuring a language resource related to a noun, which is considered to be necessary for implementing a system that executes a task of specifying content or an entity of a noun in an utterance or text in natural language processing by a computer in consideration of how much it is required to specify the entity or content referred to by the noun or how to present a specification result.

### Solution to Problem

The present disclosure includes a noun classification database that stores nouns in association with, for each noun, information regarding a possible “type of identification operation” and information regarding a “type of presentation method” of an applicable identification result, and searches for, regarding a designated noun, information that specifies or describes an entity of the noun from a background knowledge database on the basis of information regarding corresponding “type of identification operation” and “type of presentation method”.

A data structure of a language resource of the present disclosure is
a data structure of a language resource used for natural language processing by a computer, and
includes, in a data element, at least one of:
information regarding a possible “type of identification operation” for each of nouns of a target language; or
information regarding a “type of presentation method” of an applicable identification result for each of the nouns of the target language.

An utterance understanding support device of the present disclosure
includes:
an utterance sentence analysis unit that performs structural analysis of an individual utterance sentence having been input and context analysis based on an utterance history when an utterance by a user who is a communication participant is input by text input;
a database search unit that searches a background knowledge database in which background knowledge of communication is held in a form of database having the data structure according to any of claims 1 to 3 in order to specify an entity referred to by a noun included in an ambiguous portion when a part of an utterance sentence by a communication participant is designated as the ambiguous portion in a client terminal that is a communication participant; and
a user interface application that displays, on a client terminal in which the ambiguous portion is designated, information describing an entity referred to by the ambiguous portion, the entity being specified by a result of search by the database search unit.

In an utterance understanding support method of the present disclosure,
an utterance sentence analysis unit performs structural analysis of an individual utterance sentence having been input and context analysis based on an utterance history when an utterance by a user who is a communication participant is input by text input;
a database search unit searches a background knowledge database in which background knowledge of communication is held in a form of database having the data structure of the present disclosure in order to specify an entity referred to by a noun included in an ambiguous portion when a part of an utterance sentence by a communication participant is designated as the ambiguous portion in a client terminal that is a communication participant; and
a user interface application displays, on a client terminal in which the ambiguous portion is designated, information describing an entity referred to by the ambiguous portion, the entity being specified by a result of search by the database search unit.

A program of the present disclosure is a program for implementing a computer as each of functional units included in a communication device according to the present disclosure, and is a program for causing the computer to execute each of steps included in a communication method executed by the communication device according to the present disclosure.

### Advantageous Effects of Invention

According to the present disclosure, it is possible to provide a method of configuring a language resource related to a noun, which is considered to be necessary for implementing a system that executes a task of specifying content or an entity of a noun in an utterance or text in natural language processing by a computer in consideration of how much it is required to specify the entity or content referred to by the noun or how to present a specification result.

### BRIEF DESCRIPTION OF DRAWINGS

FIG. 1 is a diagram for describing identification of a type name and individual identification in a first embodiment of the present disclosure with reference to exemplary nouns.

FIG. 2 is a diagram for describing identification of another noun representing an entity or a noun for which another description is required in the first embodiment of the present disclosure with reference to exemplary nouns.

FIG. 3 is a diagram illustrating an example of noun classification according to the first embodiment of the present disclosure.

FIG. 4 is a diagram illustrating a system of a second embodiment of the present disclosure.

FIG. 5 is a diagram illustrating a configuration of a display screen in the second embodiment of the present disclosure.

FIG. 6A is a diagram illustrating a flowchart of operation of a database search unit in the second embodiment of the present disclosure.

FIG. 6B is a diagram illustrating a flowchart of the operation of the database search unit in the second embodiment of the present disclosure.

FIG. 6C is a diagram illustrating a flowchart of the operation of the database search unit in the second embodiment of the present disclosure.

FIG. 6D is a diagram illustrating a flowchart of the operation of the database search unit in the second embodiment of the present disclosure.

FIG. 6E is a diagram illustrating a flowchart of the operation of the database search unit in the second embodiment of the present disclosure.

FIG. 6F is a diagram illustrating a flowchart of the operation of the database search unit in the second embodiment of the present disclosure.

FIG. 6G is a diagram illustrating a flowchart of the operation of the database search unit in the second embodiment of the present disclosure.

### DESCRIPTION OF EMBODIMENTS

Embodiments of the present disclosure will be described below in detail, with reference to the drawings. Note that the present disclosure is not limited to the following embodiments. These embodiments are merely examples, and the present disclosure can be carried out in a form with various modifications and improvements based on the knowledge of those skilled in the art. Note that components having the same reference signs in the present description and the drawings indicate the same components.

### First Embodiment

A first embodiment of the present disclosure will be described.

A device of the present disclosure includes a memory that stores language resources of nouns having a data structure of the present disclosure. In the language resources of nouns in the present embodiment, the following classification information regarding a possible “type of identification operation” is held.
(1-1) A type for which only identification of type name/differentiation name among cognate types is required
(1-2) A type for which there is a case where identification of a type name is sufficient and a case where individual identification is also required
(1-3) A type for which Individual identification is required
(1-4) A type for which identification of another noun representing an entity or another description is required
(1-5) A type for which identification is unnecessary/impossible

In addition, the following classification information regarding a “type of presentation method” of an applicable identification result is held.
(2-1) An entity file on a computing machine
(2-2) Description (name/description sentence/numeral)
(2-3) An alternative file (picture/photograph/symbol)

Hereinafter, each will be described (note that, in the following, “identification” and “specification” are used in the same meaning, and there is no difference in meaning between them).

In the first place, in noun identification operation,
three pieces of operation are conceivable including:
(a) type name specification operation for identifying a type among cognate types;
(b) operation of identifying an individual of a noun for which an entity exists; and
(c) operation of identifying another noun corresponding to a target noun rather than a conceptual entity of the target noun itself.

For example, taking a vehicle as an example, the operation (a) is identification that specifies which vehicle type the vehicle is among cognate objects of vehicles. On the other hand, the operation (b) is identification that specifies a vehicle as an individual (an individual identified by a number of a license plate). The operation (c) is not a description or identification of a target noun itself but operation of specifying another noun corresponding to the noun in terms of content. For example, taking a noun “affiliation” as an example, it is considered that, in specification operation for content referred to by the “affiliation” of a phrase “affiliation of Mr. XX” using the noun, specification of a name of an organization to which “Mr. XX” belongs is required rather than acquiring a description of what the affiliation is. The operation (c) refers to such identification operation.

(1-1) to (1-5) are classifications provided from the viewpoint of which operation among these operations is likely to be requested by each noun in a target language in the identification operation, on the assumption that the pieces of operation such as (a) to (c) exist in the noun identification operation.

In the present embodiment, for each noun of the target language, information (classification tag) on which of these identification operation types the noun belongs to, that is, one of classification tags in a one-to-one correspondence with (1-1) to (1-5) is added. Note that, regarding the “type of identification operation”, one tag is added to one noun due to the nature of the classification method. That is, one noun is not classified into a plurality of items of (1-1) to (1-5).

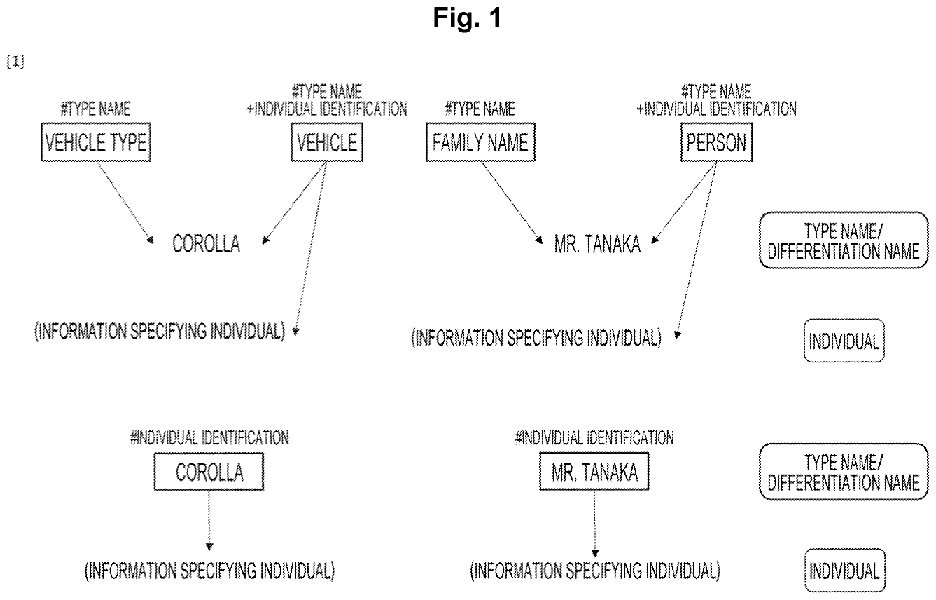

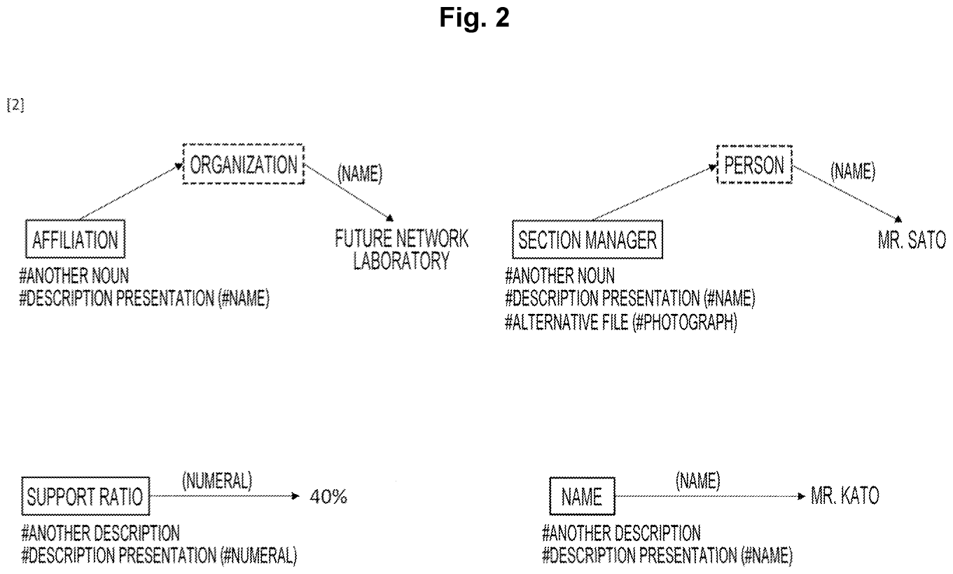

Hereinafter, these will be described in detail with reference to FIGS. 1 and 2.

First, (1-1) to (1-3) will be described with reference to FIG. 1. Examples of nouns “vehicle” and “person” indicated in the figure are examples of nouns having classification information of (1-2) (in order to indicate this point, a tag “#type name+individual identification” that is a tag corresponding to this classification is also indicated in the figure). For the noun “vehicle”, for example, in a case where it is desired to specify a “vehicle” in a phrase “a vehicle on which Mr. A is riding”, identification of a vehicle type name such as “corolla”, that is, identification of a type name among vehicles as cognate types is required in many cases, and it is considered sufficient. However, for example, in a case where it is desired to specify a “vehicle of Mr. A” in a photograph in which a plurality of vehicles is photographed, individual identification is required that specifies which vehicle in the photograph the “vehicle of Mr. A” is. The same applies to the noun “person” in the figure, and for example, in a case where it is desired to specify a “person” in a phrase “person whom you met yesterday”, identification of a person's name such as “Mr. Tanaka”, that is, identification of a differentiation name among persons as cognate types is required in many cases, and it is considered sufficient. However, for example, in a case where a “person who has just come to greet” is not familiar and it is not possible to remember who the person is, it is necessary to specify an individual who the person is among persons who met in the past.

For these nouns, “vehicle type” and “family name” in the figure are nouns themselves meaning a type name and a differentiation name of a vehicle or a person, and thus have classification information of (1-1) (in order to indicate this point, a tag “#type name” is also indicated).

In addition, since “Corolla” and “Mr. Tanaka” in the figure themselves are a specific type name and a differentiation name of a vehicle and a person, they serve as results of identification of a type name and a differentiation name of certain nouns. Thus, in a case where these nouns themselves are targets of the identification operation, there is no case other than a case where identification more specialized than the type name and the differentiation name, that is, individual identification is required. Thus, these nouns are nouns having classification information of (1-3) (in order to indicate this point, a tag “#individual identification” is also indicated).

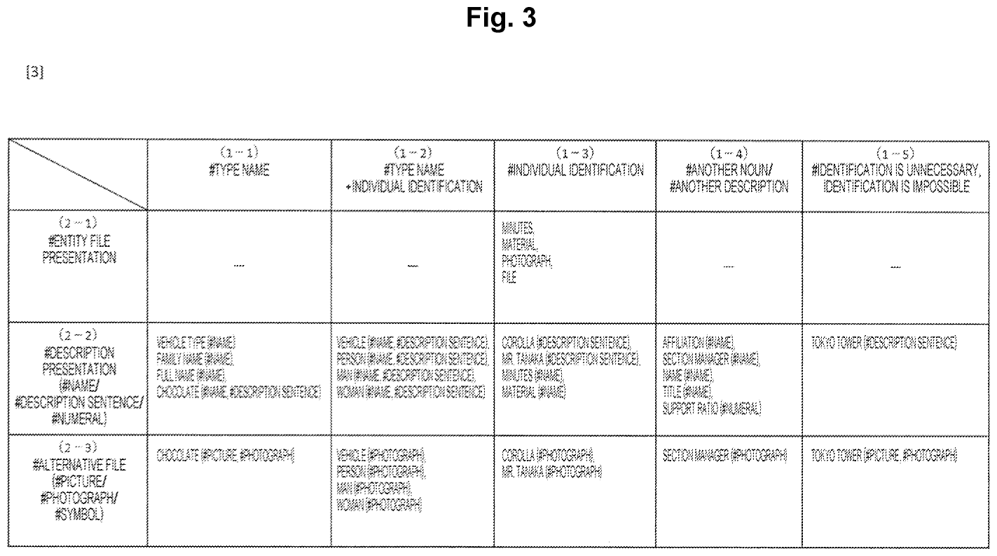

Next, (1-4) will be described with reference to FIG. 2. (1-4) is a noun on which the above-described identification operation of (c) can be performed. For example, taking the noun “affiliation” in the figure as an example, in a case of specifying “affiliation” of a phrase “affiliation of Mr. B”, it is considered that identification of another noun “organization” representing the entity of the “affiliation” is required rather than the meaning of the noun “affiliation” itself (In order to indicate this point, a tag “#another noun” is also indicated together with the noun “affiliation”. In addition, since it is considered that the identification result can be presented by the name of the another noun, a tag “#description presentation (#name)” is also indicated. A tag related to an identification result presentation method will be described later in description of FIG. 3). Note that a method for finding appropriate another noun is not defined in the present disclosure (the method can be executed by using a concept dictionary or the like).

The same applies to an example of a noun “section manager” in the figure, and in a case of specifying a “section manager” of a phrase “the section manager of the section XX”, it is considered that identification of another noun “person” representing the entity of the “section manager” is required rather than the meaning of the noun “section manager” itself. Note that, for presentation of a result of identification of the noun, a method of presenting a file of a photograph of the person is also conceivable, and thus a tag “#alternative file (#photograph)” for the identification result presentation method is also indicated together.

In addition, nouns such as “support ratio” and “name” in the figure are examples of nouns for which another description is required (thus, a tag “#another description” is also indicated). For example, in a case of specifying a “support ratio” of the phrase “support ratio of XX cabinet”, it is considered that a description of what value the “support ratio” has is required rather than the meaning of the noun “support ratio” itself (thus, a tag “#description presentation (#numeral)” is also indicated). The same applies to the example of the noun “name” in the figure, and in a case of specifying a “name” of a phrase “the name of the section manager of the YY section”, it is considered that a description of what the name is, is required rather than the meaning of the noun “name” itself (thus, the tag “#description presentation (#name)” is also indicated).

Next, examples of a noun having classification information of (1-5) include a noun such as “Tokyo Tower”, that is, a noun that does not require any identification operation because it has a unique entity.

Next, classification information of (2-1) to (2-3) will be described. These are classification information regarding a method of presenting a result of identification of an entity of a noun. In the present embodiment, for each noun of the target language, in addition to the classification tag representing the type of the identification operation described above, classification tags for these types of presentation methods, that is, classification tags in a one-to-one correspondence with (2-1) to (2-3) are added. Note that, for this “type of presentation method”, a plurality of presentation methods may be considered even for the same noun, and thus a plurality of tags may be added to one noun.

In a case where an entity (actual object) of a noun to be identified is a file stored in a computing machine, (2-1) is a noun for which the identification result can be present by presenting the file. Although the entity of the noun to be identified is not a file on the computing machine and the entity file cannot be presented, (2-2) is a noun for which the identification result can be presented by the name of the noun, the result of identification of another noun serving as a description (name or description sentence), a semantically corresponding numeral, or the like. Although the entity of the noun to be identified is not a file on the computing machine and the entity file cannot be presented, there is an alternative file that can present an appearance of the entity of the noun, such as a picture, a photograph, or a symbol, and (2-3) is a noun for which the identification result can be presented by the alternative file.

The above is the description regarding the classification information in the embodiment of the present disclosure. Next, an example in which nouns are classified on the basis of the classification information is illustrated in FIG. 3. The horizontal axis of the table in the figure indicates the “type of identification operation”, and the vertical axis indicates the “type of presentation method”. To each noun in the table, classification tags on corresponding horizontal and vertical axes are added (a character string starting with # in the table is a classification tag).

An auxiliary tag (#name, #description sentence, #numeral) that defines a type of information used for description is further added to a noun to which the tag (#description presentation) of (2-2) is added. In addition, an auxiliary tag (#picture, #photograph, #symbol) that defines a type of an alternative file is further added to a noun to which the tag (#alternative file) of (2-3) is added. For these nouns, an auxiliary tag to be added is indicated clearly for each noun described in the table.

The main nouns in the table will be described.

It is considered that, for a noun related to a person such as a vehicle, a person, a man, a woman, or the like, the identification result can be presented by description presentation, such as a name (full name), a description sentence that leads to individual identification associated with personal experience, or the like, and the identification result can also be presented by a photograph file obtained by photographing an individual.

It is considered that, for a noun representing a type such as Corolla, Mr. Tanaka, or the like, the identification result can also be presented by a photograph file obtained by photographing an individual, in addition to a description sentence that leads to individual identification associated with personal experience.

For nouns that can themselves be files on a computing machine, such as minutes and materials, it is considered that the identification result can also be presented by names such as titles added to the minutes and materials, in addition to presenting the entity file itself.

It is considered that, for a noun such as a chocolate, the identification result can also be presented by presentation of an alternative file on a computer storing a picture or a photograph of a package, in addition to a description presentation of a name of the noun, a description sentence that leads to individual identification associated with personal experience, or the like.

In the present disclosure, a tag is added assuming that presentation operation for recognizing an individual is executed even for a noun that does not originally need individual identification operation, such as Tokyo Tower. For example, it is operation in a case where a communication party confirms which of several known towers the Tokyo tower is. Thus, as the presentation operation, it is conceivable to present a description sentence that leads to identification associated with personal experience, rather than a general description regarding Tokyo Tower. In addition, it is considered that a file of a picture or a photograph depicting an actual object can be presented.

### Second Embodiment

A second embodiment of the present disclosure will be described.

The present embodiment is an example of a communication system that has data of the language resources described in the first embodiment and uses the content thereof to perform specification of an entity of a noun whose entity in an utterance sentence is ambiguous and perform presentation of a result of the specification.

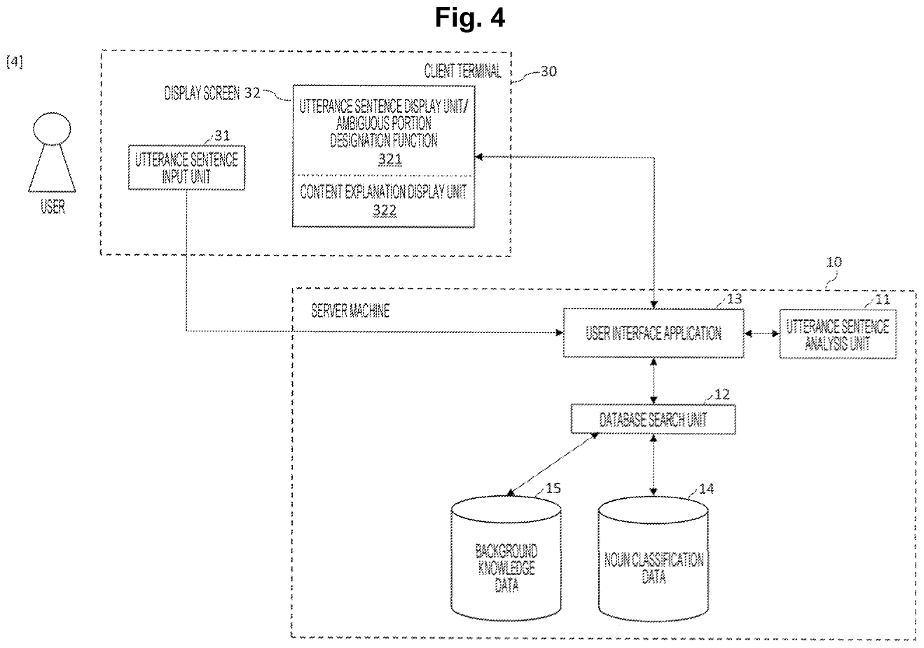

A configuration of a system of the present embodiment is illustrated in FIG. 4. In the communication system of the present disclosure, a client terminal 30 is connected to a server machine 10. The server machine 10, and the client terminal 30 can also be implemented by a computer and a program, and the program can be recorded in a recording medium or provided through a network.

Each user of the present system participates in communication via the client terminal 30 occupied by the user. The client terminal 30 includes an utterance sentence input unit 31 that inputs utterance of each user and a display screen 32 serving as an interface. The display screen 32 includes an utterance sentence display unit 321 that displays an utterance sentence of each user and a content explanation display unit 322. The utterance sentence display unit 321 has an ambiguous portion designation function for the user to designate a noun appearing therein having an ambiguous entity.

In the server machine 10 different from the client terminal 30, an utterance sentence analysis unit 11, a database search unit 12, and a user interface application 13 operate. The user interface application 13 has a function of receiving an utterance sentence from the utterance sentence input unit 31, analyzing the utterance sentence using the utterance sentence analysis unit 11, searching a background database using the database search unit 12, and controlling the display screen 32, and plays a role of a control module of the entire system.

In addition, on the server machine 10, there is a memory that stores background knowledge data 15 and noun classification data 14. The background knowledge data 15 is data including attribute information of a user of the present system who participates in or is likely to participate in communication, a history regarding communication and various actions, digital information generated as a result thereof, and the like, and is used as a basis in noun entity specification processing described above. The noun classification data 14 is the language resource related to the noun described in the first embodiment of the present disclosure, and is data obtained by digitizing the language resource.

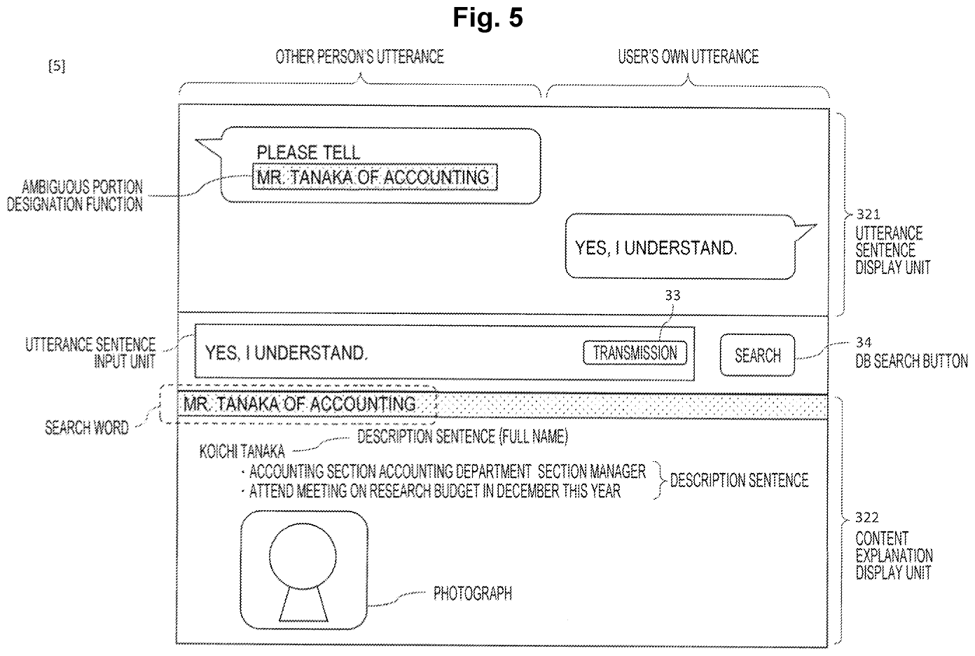

FIG. 5 is a diagram illustrating a configuration of the display screen 32 in the client terminal 30. With reference to FIGS. 4 and 5, a description will be given of operation performed on the display screen 32 of FIG. 5 by the user at the time of use of the communication system of the present embodiment and operation of each unit in FIG. 4 that occurs correspondingly.

In a case of making an utterance, the user inputs a text sentence having content desired to utter into the utterance sentence input unit 31 of the user's own client terminal 30 illustrated in FIG. 5, and presses down a transmission button 33 in the figure. By pressing down the transmission button 33, the text sentence input to the utterance sentence input unit 31 and an identifier (methods for generating and managing this identifier are not defined in the present description) for identifying an utterer are transmitted to the user interface application 13 of the server machine 10 in FIG. 4.

The user interface application 13 that has received the text sentence and the identifier of the utterer transmits the received text sentence and the identifier of the utterer to the utterance sentence display units 321 of all the client terminals 30, and adds the information to an utterance history. The user interface application 13 internally accumulates all the utterances of all the users as the utterance history so that a context of an utterance can be grasped.

The utterance sentence display unit 321 of each client terminal 30 has received the text sentence and the identifier of the utterer, and if the received identifier of the utterer is the identifier corresponding to the user of the terminal, displays the received text sentence on the user's own utterance portion of the utterance sentence display unit 321 in FIG. 5. If the received identifier of the utterer is not the identifier corresponding to the user of the terminal, the received text sentence is displayed on an utterance portion of other person in the utterance sentence display unit 321 in FIG. 5.

Through the above procedure, communication progresses while the content of the utterance of each user is shared. Having found an ambiguous noun whose entity or content cannot be specified in an utterance sentence by other person or the user himself/herself during progress of communication, the user highlights the portion as in the example of FIG. 5 using the ambiguous portion designation function, and presses down a DB search button 34. By pressing down the DB search button 34, the text sentence of the utterance, the text portion designated as an ambiguous portion, and an identifier for identifying the utterer of the utterance are transmitted to the user interface application 13 of the server machine 10 in FIG. 4.

The user interface application 13 that has received this information uses the utterance sentence analysis unit 11 to execute syntax analysis of a portion designated as the ambiguous portion. Then, a result of the syntax analysis (a noun of the portion designated as the ambiguous portion and information of a modifying portion thereof) is passed to the database search unit 12.

The database search unit 12 that has received the above information searches a table of the background knowledge database unit 15 using the received information, and transmits the acquired inspection result, that is, information serving as the entity or description of the noun expression designated as the ambiguous portion to the user interface application 13. The user interface application 13 forwards the received search result to the content explanation display unit 322 of each client terminal 30.

The content explanation display unit 322 displays the received search result on the display screen 32. As illustrated in FIG. 5, the text portion designated as the ambiguous portion is set as the title, and the received search result, that is, the information serving as the entity or description of the noun expression designated as the ambiguous portion (name, description sentence, file name, and the like) is displayed on the screen.

The above is an outline of the operation performed on the display screen of FIG. 5 and the operation of each unit in FIG. 4 that occurs correspondingly.

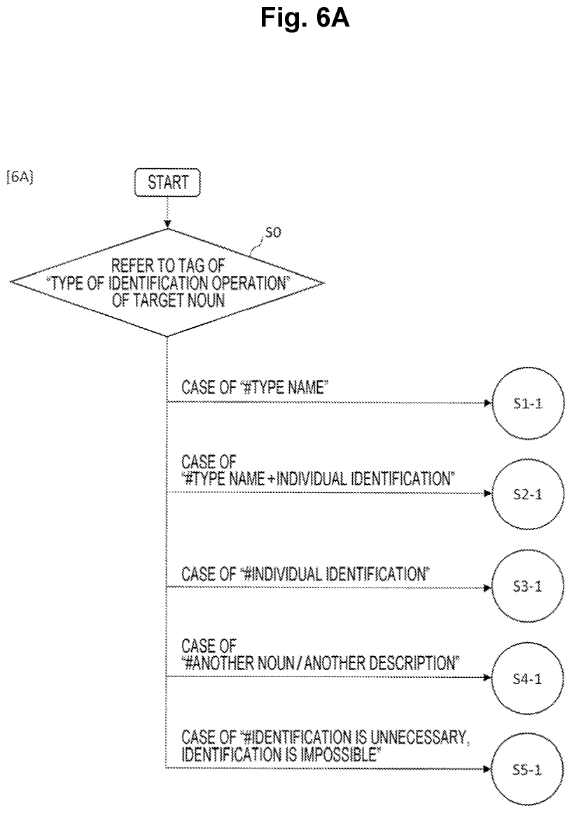

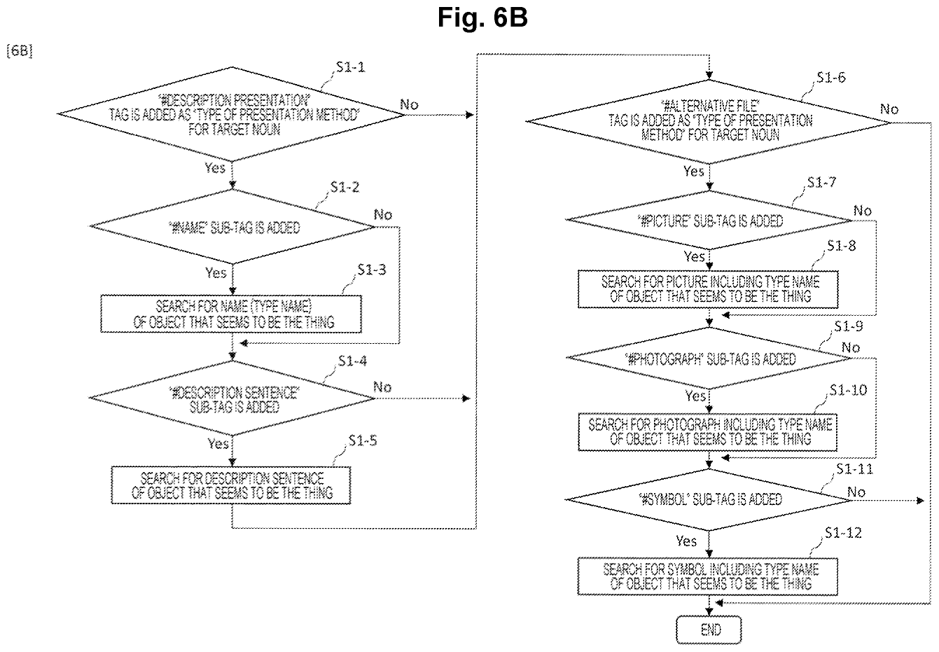

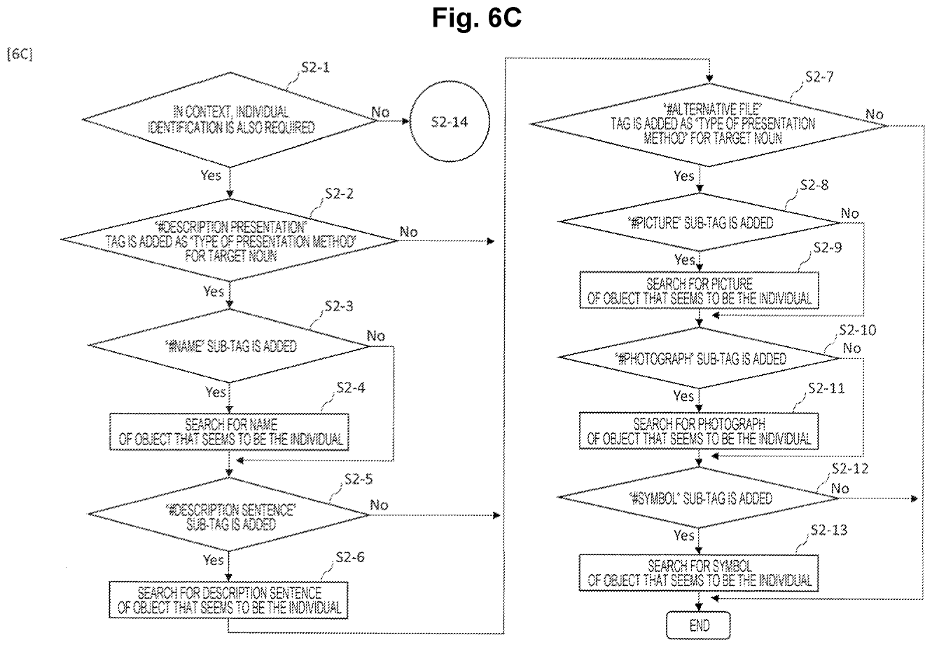

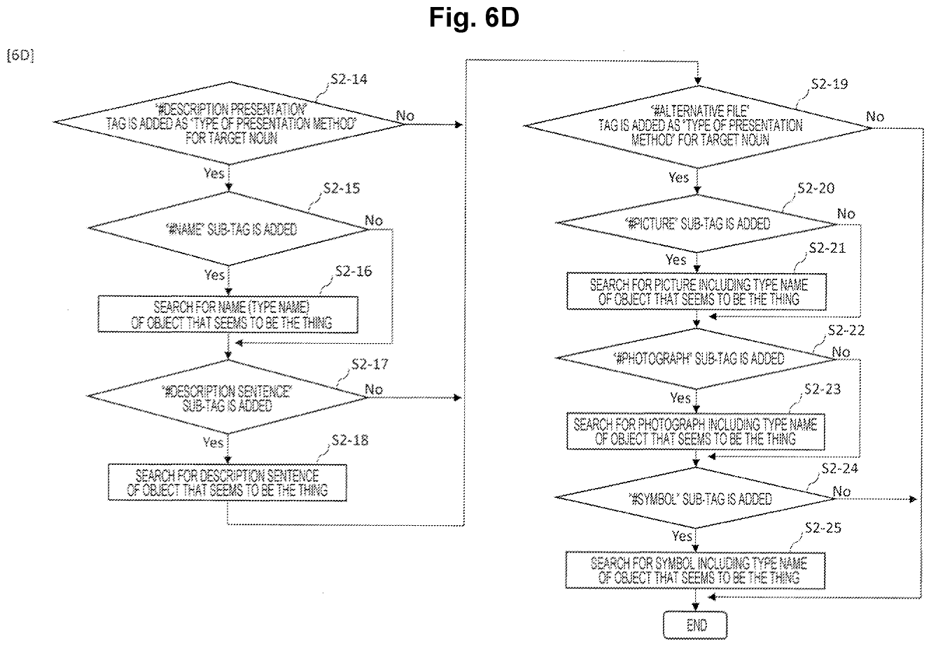

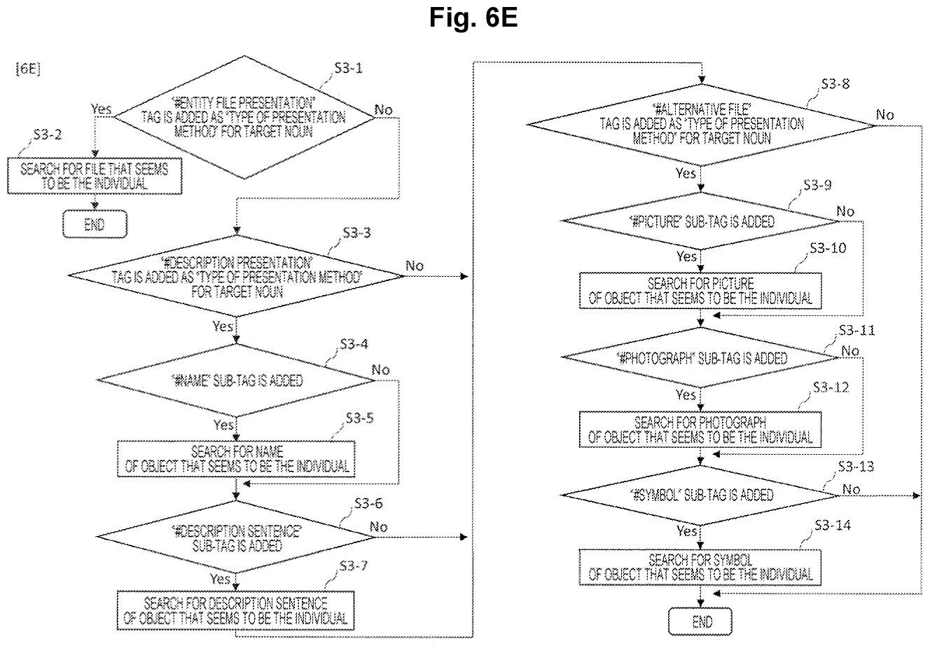

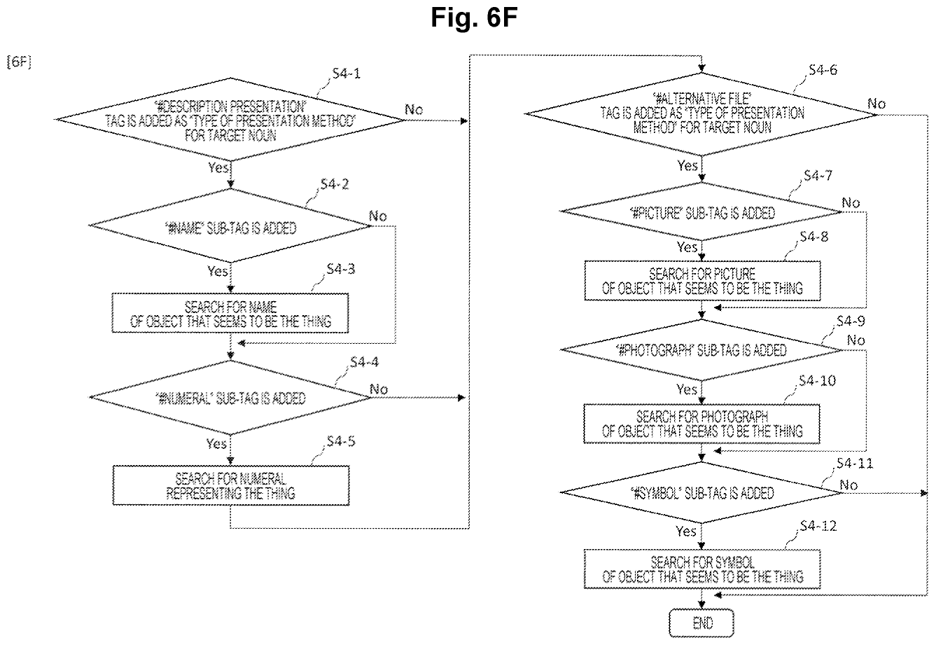

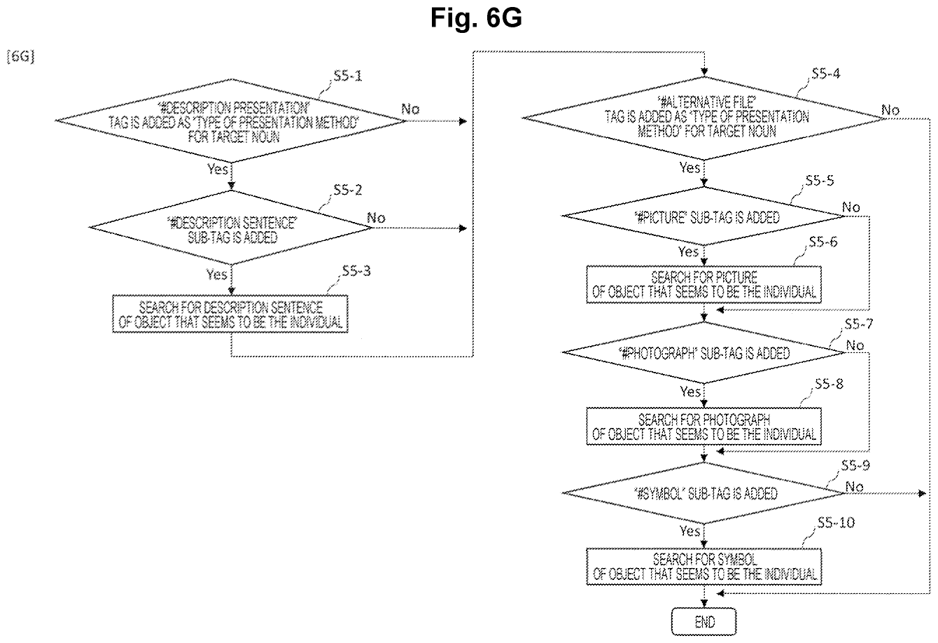

Operation of the database search unit 12 will be described. The database search unit 12 that has received a search request from the user interface application 13 performs entity specification of a target noun using the noun classification data 14 and the background knowledge data 15 of the present disclosure. FIG. 6 illustrates a flowchart of the database search unit 12.

As illustrated in FIG. 6A, the database search unit 12 that has received the search request first refers to the noun classification data 14 and refers to a tag of the “type of identification operation” added to the entity specification target noun (step S0). Then, processing corresponding to a value of the tag is executed.

FIG. 6B is a flowchart illustrating processing in a case where the value of the tag of “type of identification operation” is “#type name”. As illustrated in FIG. 3, in this type of noun, “#entity file presentation” is not added as the “type of presentation method” tag, and it is considered that “#description presentation” or “#alternative file” may be added (both may be added).

Thus, the database search unit 12 refers to the noun classification data 14 to inspect whether “#description presentation” or “#alternative file” is added as a tag of the type of presentation method to the noun as the entity specification target (step S1-1 and S1-6), and if each tag is added, further examines a sub-tag (steps S1-2, S1-4, S1-7, S1-9, and S1-11), searches the background knowledge data 15 for content of the sub-tag that seems to represent the entity of the target noun, and sets the content as an entity specification result (steps S1-3, S1-5, S1-8, S1-10, and S1-12).

In this type of noun, since it is not conceivable that “#numeral” is added as a sub-tag of “#description presentation”, the database search unit 12 does not inspect the presence or absence of this sub-tag. Note that, in the present disclosure, the content and format of the background knowledge data 15 and a specific method of specifying the entity of the target noun using the background knowledge data 15 are not defined.

FIGS. 6C and 6D are flowcharts illustrating processing in a case where the value of the tag of “type of identification operation” is “#type name+individual identification”. As described in the first embodiment, in this type of noun, depending on a context of dialogue, there are a case where identification of a type name is required for the entity of the noun, and a case where not only the identification but also individual identification is required. Thus, the database inspection unit 12 determines whether individual identification is also required on the basis of the context of the dialogue (step S2-1). Note that a specific method for making this determination is not defined in the present disclosure.

When it is determined that the individual identification is also required, the database search unit 12 executes the processing of steps S2-2 to S2-13. That is, as in the case of FIG. 6B, the database search unit 12 first inspects whether a “#description presentation” or “#alternative file” tag is added as a tag indicating the type of presentation method (steps S2-2 and S2-7). Then, the database search unit 12 further searches for content that seems to identify the individual to be the entity of the target noun depending on the sub-tag of each tag (steps S2-4, S2-6, S2-9, S2-11, and S2-13). Note that, also in a case where the value of the tag of the type of identification operation is “#type name+individual identification”, similarly to the case where the value is “#type name”, it is not conceivable that “#numeral” is added as a sub-tag of “#description presentation”, and the database search unit 12 does not inspect the presence or absence of this sub-tag.

In a case where it is determined that the individual identification is not required, the database search unit 12 executes the processing of steps S2-14 to S2-25 of FIG. 6D. These pieces of processing are similar to those of FIG. 6C. However, in the search of the background knowledge data 15 (steps S2-16, S2-18, S2-21, S2-23, and S2-25), the database search unit 12 searches for content that leads to identification of the type name, not the individual that is the entity of the target noun.

FIG. 6E is a flowchart illustrating processing in a case where the value of the tag of “type of identification operation” is “#individual identification”. As illustrated in FIG. 3, in the case of this type of noun, it is conceivable that “#entity file presentation” is added in addition to “#description presentation” and “#alternative file” as a tag indicating “type of presentation method”. In a case of a noun to which a “#entity file presentation” tag is added, that is, a noun whose entity is stored as a file on a computing machine, it is not conceivable that a “#description presentation” or a “#alternative file” tag is added as a tag indicating “type of identification operation”. Thus, in a case of detecting that the “#entity file presentation” tag is added in step S3-1, the database search unit 12 searches for a file considered to be the entity of the target noun (step S3-2), and ends the processing. The processing in a case of detecting that the “#entity file presentation” tag is not added in step S3-1 (steps S3-3 to S3-14) is similar to that in FIG. 6C.

FIG. 6F is a flowchart illustrating processing in a case where the value of the tag of “type of identification operation” is “#another noun/another description”. The processing in this case is substantially similar to the processing (FIG. 6B) in the case where the value of the tag of “type of identification operation” is “#type name”, but is different in that “#description sentence” is not added as the sub-tag of “#description presentation”, and instead, a “#numeral” sub-tag may be added.

FIG. 6G is a flowchart illustrating processing in a case where the value of the tag of “type of identification operation” is “#identification is unnecessary, identification is impossible”. The processing in this case is substantially similar to the processing (FIG. 6B) in the case where the value of the tag of “type of identification operation” is “#type name”, but is different in that only the “#description sentence” sub-tag may be added as the sub-tag of “#description presentation”.

As described above, the present disclosure is characterized by constructing, for each noun, a language resource that holds information regarding a possible “type of identification operation” and a “type of presentation method” of an applicable identification result.

Specifically, the following classification information is held for the possible “type of identification operation”.
A type for which only identification of type name/differentiation name among cognate types is required
A type for which there is a case where identification of a type name is sufficient and a case where individual identification is also required
A type for which Individual identification is required
A type for which identification of another noun representing an entity or another description is required
A type for which identification is unnecessary/impossible

In addition, the following classification information is held for the “type of presentation method” of the applicable identification result.
An entity file on a computing machine
Description (name/description sentence/numeral)
An alternative file (picture/photograph/symbol)

### Effects of the Present Disclosure

The present disclosure constructs, for each noun, a language resource that holds information regarding a possible “type of identification operation” and a “type of presentation method” of an applicable identification result, and thus, it is possible to solve the problem of the present disclosure, that is, a problem that there is no language resource related to a noun necessary for implementing a system that executes a task of specifying content or an entity of a noun in utterance or text, in consideration of how much it is required to specify the entity or content referred to by the noun or how to present a specification result.

### INDUSTRIAL APPLICABILITY

The present disclosure can be applied to the information communication industry.

### REFERENCE SIGNS LIST

10 server machine
11 utterance sentence analysis unit
12 database search unit
13 user interface application
30 client terminal
31 utterance sentence input unit
32 display screen
321 utterance sentence display unit
322 content explanation display unit
33 transmission button
34 DB search button

1. A data structure of a language resource used for natural language processing by a computer,
the data structure of the language resource comprising,
in a data element, at least one of:
information regarding a possible “type of identification operation” for each of nouns of a target language; or
information regarding a “type of presentation method” of an applicable identification result for each of the nouns of the target language.

2. The data structure of a language resource according to claim 1, wherein
the type of the identification operation
includes:
(1) a type for which only identification of a type name among cognates is required;
(2) a type for which there is a case where identification of a type name is sufficient and a case where individual identification is also required;
(3) a type for which individual identification is required;
(4) a type for which identification of another noun representing an entity or another description is required; and
(5) a type for which identification is unnecessary or impossible.

3. The data structure of a language resource according to claim 1, wherein
the type of the presentation method includes:
(1) an entity file on a computing machine;
(2) description; and
(3) an alternative file,
and
in a case where the type of the presentation method is the description, an auxiliary tag that defines a type of information used for the description is associated, and
in a case where the type of the presentation method is the alternative file, an auxiliary tag that defines a type of the alternative file is associated.

4. A device equipped with a language resource having the data structure according to claim 1.

5. An utterance understanding support device comprising:
an utterance sentence analysis unit that performs structural analysis of an individual utterance sentence having been input and context analysis based on an utterance history when an utterance by a user who is a communication participant is input by text input;
a database search unit that searches a background knowledge database in which background knowledge of communication is held in a form of database having the data structure according to claim 1 in order to specify an entity referred to by a noun included in an ambiguous portion when a part of an utterance sentence by a communication participant is designated as the ambiguous portion in a client terminal that is a communication participant; and
a user interface application that displays, on a client terminal in which the ambiguous portion is designated, information describing an entity referred to by the ambiguous portion, the entity being specified by a result of search by the database search unit.

6. An utterance understanding support method, comprising:
performing, by an utterance sentence analysis unit, structural analysis of an individual utterance sentence having been input and context analysis based on an utterance history when an utterance by a user who is a communication participant is input by text input;
searching, by a database search unit, a background knowledge database in which background knowledge of communication is held in a form of database having the data structure according to claim 1 in order to specify an entity referred to by a noun included in an ambiguous portion when a part of an utterance sentence by a communication participant is designated as the ambiguous portion in a client terminal that is a communication participant; and
displaying, by a user interface application, on a client terminal in which the ambiguous portion is designated, information describing an entity referred to by the ambiguous portion, the entity being specified by a result of search by the database search unit.

7. A non-transitory computer-readable medium having computer-executable instructions that, upon execution of the instructions by a processor of a computer, cause the computer to function as functional units according to claim 5.
